(19) United States
(12) Patent Application Publication
(10) Pub. No.: US 2011/0184076 A1
(43) Pub. Date: Jul. 28, 2011

(54) FULLERENE COMPOSITE MEMBRANES FOR DIRECT METHANOL FUEL CELL

(75) Inventors: Fred Wudl, Santa Barbara, CA (US); Galen Stucky, Santa Barbara, CA (US); Ken Tasaki, Redondo Beach, CA (US); Hengbin Wang, Camarillo, CA (US); Jeffrey V. Gasa, Goleta, CA (US); Ryan DeSousa, Fort Worth, TX (US)

(73) Assignee: THE REGENTS OF THE UNIVERSITY OF CALIFORNIA, Oakland, CA (US)

(21) Appl. No.: 11/677,688

(22) Filed: Feb. 22, 2007

Related U.S. Application Data
(60) Provisional application No. 60/776,518, filed on Feb. 23, 2006.

(51) Int. Cl. C08J 5/22; C08K 3/04; C08L 27/22; B82B 1/00

(52) U.S. Cl. 521/27; 977/753

(57) ABSTRACT

For use in a DMFC, a proton-conducting membrane containing a proton-conducting host polymer and a functionalized fullerene having one or more proton accepting or proton donating functional groups selected from: >C[PO(OH)₂]₂; —PO(OH)₂; —OH; —SO₃H; —NH₂; —CN; —HOSO₃H; —COOH; —OPO(OH)₂; and —OSO₃ or a combination of two or more of these groups attached to the fullerene.

### CROSS-REFERENCE TO RELATED APPLICATIONS

This application claims priority from U.S. provisional application Ser. No. 60/776,518, filed on Feb. 23, 2006, incorporated herein by reference in its entirety.

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC

Not Applicable

### BACKGROUND OF THE INVENTION

1. Field of the Invention

This invention pertains generally to a direct methanol fuel cells and composite fuel cell membranes having a functionalized fullerenes dispersed within the membranes. More particularly the subject inventions discloses membranes fabricated from a proton-conducting host polymer and functionalized fullerenes that disperse within the host polymer, wherein the functional groups are proton acceptors or proton donors and, when associated with fullerenes in the membrane, limit the amount of methanol crossover for the membrane.

2. Description of Related Art

Direct methanol fuel cells (DMFCs) are increasingly important, becoming a choice for fuel cells for portable applications such as batteries for laptop computers and cell phones. One of the most serious technical hurdles in development of DMFCs is the methanol (MeOH) permeation through a membrane, other known as “the methanol crossover,” which: 1) reduces the power of the DMFC when methanol reaches the cathode to be oxidized by the oxygen; 2) loses the actual fuel, thus decreasing the fuel efficiency; 3) requires low concentrations of MeOH which enlarges unnecessarily the dimensions of the fuel tank; 4) reduces, as a result of the increased dimensions, the energy density of the DMFC; and 5) makes it difficult to operate at high temperatures which would increase the catalytic activity, if possible. Most membranes used in DMFCs utilize water as a proton-conducting medium, and thus, blocking MeOH by the membrane, while water freely permeates through the membrane, have turned out to be extremely difficult. Currently, the industrial standard membrane, Nafion (Nafion is a trademark of the DuPont Corporation) is known to be highly methanol permeable (˜170×10⁻⁸ cm²s⁻¹), thus, reducing the power and the fuel efficiency in DMFC operation. Several new membranes have been developed to reduce the methanol crossover. BPSH (poly(arylene ether sulfone)-based membranes) is a newer aromatic hydrocarbon polymer membrane that reduces methanol crossover of Nafion by about 70% (Kim, Y. S.; Sumner, M. J.; Harrison, W. L.; Riffle, J. S.; McGrath, J. E.; Pivovar, B. S. J.), but the membranes tend to have lower proton conductivity than Nafion unless the degree of sulfonation is increased, which leads to higher MeOH crossover and undesirable swelling of the membrane. Similarly, another hydrocarbon-based membrane, developed by PolyFuel Corporation, has also around ⅓ of Nafion's methanol crossover (The PolyFuel Website: http://www.polyfue1.comItechnology/methano1.html). Again, the problem is that most improvements of methanol crossover over Nafion's values come at the expense of the proton conductivity, as explained further below. The Sony Corporation has filed a patent application (Hinokuma, K Tokukai 2002-63917, Tokugan P 2000-248034, Feb. 28, 2002) on the fullerene derivatives, but it shows no data on the MeOH crossover, and furthermore, it uses fullerene as the main component of the fuel cell membrane, whereas the subject invention requires fullerene as only a minor component. Also, the Sony Corporation developed proton-conducting materials using fullerene phosphonic acid (Li, Y., M.; Hinokuma, K Solid State Ionies, 2002, 150, 309). However, that material was a pellet having little practical use as a fuel cell membrane. Furthermore, no application for DMFC was described.

Additional problems exist in the prior art. It is known that the higher the equivalent weight (B.W.) of the membrane, the higher the water drag coefficient, thus, more water permeating through the membrane (Ren, X.; Gottesfeld, S. J. Elecrochem. Soc. 2001, 148, A87). There is a linear correlation between the water drag coefficient and the methanol crossover (Kim, Y. S.; Dong, L.; Rickner, M. A.; Glass, T. E.; Webb, V; McGrath, J. E, Macromolecules 2003, 36, 6281). Hence, one way to reduce the methanol crossover is to use membranes with high EW. For example, McGrath and coworkers have reduced the methanol crossover of their poly(arylene ether sulfone)-based membranes (BPSH) by reducing the degree of sulfonation to the polymer, known as BPSH-35, thus, increasing the E.W (Kim, Y. S.; Dong, L.; Rickner, M. A.; Glass, T. E.; Webb, V; McGrath, J. E, Macromolecules 2003, 36, 6281). The methanol crossover of BPSH-35 was only 20% of that of Nafion 117. However, the proton conductivity was only a half of Nafion's: 0.05 S cm⁻¹ (BPSH-35) vs. 0.1 S cm⁻¹ (Nafion 117). On the other hand, decreasing EW leads to high MeOH crossover and undesirable swelling of a membrane. Sulfonated polymer fuel cell membranes are largely dictated by this principle in general.

The methanol crossover can also be reduced by thicker membranes. DuPont has a membrane called Nafion 1210 with 250 μm thickness having almost half the methanol crossover of Nafion 117 with 175 μm thickness. However, thicker membranes result in higher ohmic resistance when assembled in a fuel cell.

Another approach would be to use methanol impermeable polymers as the membrane. For example, poly(phosphazine) is known to be methanol impermeable. In fact, Pintarou and the coworkers at Case Western Reserve University (Wycisk, R.; Lee, J. K; Pintauro, P. N. Abstract of Electrochemi. Soc. Meeting in Honolulu, Abstract 1475, October, 2004) have fabricated a membrane based on poly(phosphazine) having the methanol crossover that is 80% less than that of Nafion 117. Yet, the cell performance also decreases as the methanol crossover is reduced.

The subject invention differs from the prior art in several critical ways. Many sulfonated polymer membranes are largely constrained by the dilemma that increasing E.W. can reduce the crossover at the expense of proton conductivity. In order to break away from the dilemma generally associated with sulfonated polymer membranes, the subject invention utilizes fullerene derivatives as additives to the membranes. This novel method does not change E.W. of a given host membrane. Nor does it alter the proton conductivity, or other properties such as water uptake. If the fullerene derivative is a strong acid, it is possible to even increase the conductivity.

### BRIEF SUMMARY OF THE INVENTION

An object of the present invention is to provide a DMFC proton-conducting membrane comprised of a proton-conducting host polymer and a functionalized fullerene.

Another object of the present invention is to furnish a DMFC proton-conducting membrane comprised of a proton-conducting host polymer and a functionalized fullerene having either proton acceptor or proton donor functional groups.

A further object of the present invention is to supply a DMFC proton-conducting membrane comprised of a proton-conducting host polymer and a functionalized fullerene having at least one functional group selected from the group consisting of: >C[PO(OH)₂]₂; —PO(OH)₂; —OH; —SO₃H; —NH₂; —CN; —HOSO₃H; —COOH; —OPO(OH)₂; and —OSO₃, or a combination of two or more of those groups attached to the fullerene.

Still another object of the present invention is to disclose a proton-conducting membrane comprising one or more proton-conducting host polymers and one or more functionalized fullerenes in which the host polymer and the functionalized fullerene are either dispersed in one another or chemically attached to one another.

Disclosed are proton-conducting membranes utilized with direct methanol fuel cells that are fabricated from a proton-conducting host polymer matrix and at least one type of functionalized fullerene. The host polymers are proton-conductive and serve as a matrix into which a functionalized fullerene is mated, either mixed into or to which there is covalent chemically attachment. The host polymer may be a single proton-conducting polymer species or a combination of proton-conducting polymer species. The functionalized fullerene is functionalized with one or more groups such as: >C[PO(OH)₂]₂; —PO(OH)₂; —OH; —SO₃H; —NH₂; —CN; —HOSO₃H; —COOH; —OPO(OH)₂; and —OSO₃, or a combination of two or more of those groups attached to the fullerene.

Further objects and aspects of the invention will be brought out in the following portions of the specification, wherein the detailed description is for the purpose of fully disclosing preferred embodiments of the invention without placing limitations thereon.

### BRIEF DESCRIPTION OF THE SEVERAL VIEWS OF THE DRAWING(S)

The invention will be more fully understood by reference to the following drawing which is for illustrative purposes only:

FIG. 1 is cell utilized to determine methanol permeability of the composite membranes.

### DETAILED DESCRIPTION OF THE INVENTION

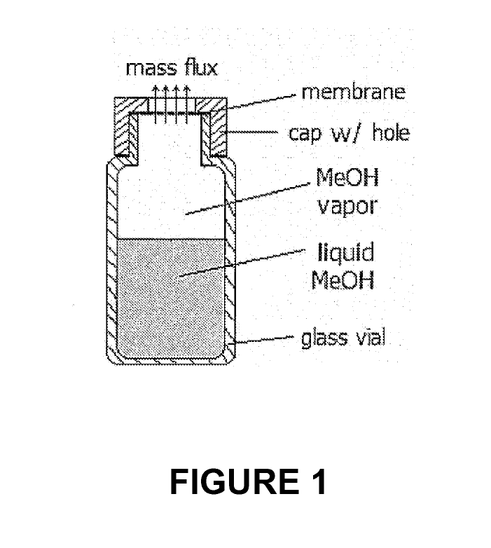

Referring more specifically to the drawing, for illustrative purposes, the present invention is embodied in the below specification and in FIG. 1. It will be appreciated that the subject invention may vary as to exact composition without departing from the basic concepts as disclosed herein.

Fullerenes (C₆₀ cage structures) can be chemically functionalized with various organic functional groups to interact strongly with MeOH. When a functionalized fullerene is mixed in a membrane with a proton-conducting host polymer, the interaction between the functionalized fullerene and MeOH will increase the drag of MeOH diffusion through the membrane, thus reducing the MeOH permeability. In order for such a function to work, the dispersion of the fullerene in the membrane is important, but may be by either physical mixing or via covalent coupling with the host polymer. Some fullerene derivatives can also attach a large amount of bound water to themselves. The interaction between the functionalized fullerene and MeOH in the membrane can be controlled by the nature of the chemical functionalization. When functionalized fullerenes are mixed in existing proton-conducting membranes, they reduce the amount of free water in the membrane. The smaller amount of free water reduces MeOH crossover. For exemplary purpose only and not by way of limitation, the fullerenes modified by phosphonic acid groups or hydroxy groups have strong interactions with MeOH and can also hold a large amount of bound water. They also have excellent miscibility with existing proton-conducting membranes such as Nafion. They are also found not to decrease the conductivity of Nafion, thus increasing the selectivity, or if the fullerene derivatives are strong acids, they can even increase the conductivity of the final membrane, thus further increasing the selectivity.

Functionalized fullerenes are dispersed, preferably evenly, within a thermally and chemically stable host polymer such as Nafion, to fabricate a membrane. Also, in place of producing a membrane in which the functionalized fullerenes are only dispersed with the host polymer, functionalized fullerenes may be covalently attached to a thermally, chemically stable polymer, to fabricate a membrane.

It should be remembered that the majority of the existing DMFC membranes use the sulfonyl (—SO₃H) group, but not associated with a fullerene, as the acidic group to impart the membrane proton conductivity and are thus governed by its chemical nature. When the EW is low, the conductivity is high, but the MeOH crossover also becomes high, with increasing swelling of the membrane. In order to break away from this dilemma, the subject invention utilizes new fullerene derivatives to control the interaction with MeOH and the state of water in the membrane, thereby decreasing the MeOH crossover, while maintaining, or sometimes increasing, the membrane conductivity, without swelling the membrane.

HOST POLYMER. The host polymers in which functionalized fullerenes are mixed or chemically attached to produce a DMFC composite membrane can be any polymer as long as they are thermally, chemically, and mechanically stable, and durable when associated with the functionalized fullerenes under typical direct methanol fuel cell operation conditions. The host polymers are proton-conductive and serve as a matrix into which a functionalized fullerene is mated, either mixed into or to which there is covalent chemically attachment. The examples include Nafion (DuPont), poly(arylene ether sulfone), poly(phosphazines), polyethers, poly(vinyl pyrrolidone), poly(phenylene ether), and other equivalent materials. The host polymer may be a single proton-conducting species or a combination of proton-conducting species.

FUNCTIONALIZED FULLERENE. The functionalized fullerene is functionalized with one or more groups such as: >C[PO(OH)₂]₂; —PO(OH)₂; —OH; —SO₃H; —NH₂; —CN; —HOSO₃H; —COOH; —OPO(OH)₂; and —OSO₃, or a combination of two or more of those groups attached to the fullerene. The amount of the functionalized fullerene within the proton-conducting membrane may vary widely from >0 wt % to <100 wt %. The functional group attached to the fullerene is either directly attached to the fullerene or separated from the fullerene cage structure by only a few atoms, usually less than or equal to about five atoms. The functionalize fullerenes may be chemically attached to the host polymer by standard means such as direct binding of various surface functional groups or by use of bifunctional or multifunctional reagents/spacers and the like that react with both the host polymer and the functionalized fullerene.

### DETAILED EXAMPLES

### Example 1

### Synthesis of Fullerene Derivatives

Polyhydroxy fullerene, C₆₀(OH)ₙ, with n=2 to 60, and specifically C₆₀(OH)₁₂ (PHF), was synthesized according to Chiang et al. (Chiang, L. Y.; Wang, L-Y.; Swirczewski, J. W.; Soled, S.; Cameron, S. J. Org. Chem. 1994, 59), through sulfonation of C₆₀ and subsequent hydrolysis (PHF). IR spectra and the elemental analysis for the compound were comparable to those published elsewhere (Lu, J.; Mau, A. W. H. Acta Polym. 1998, 49, 371). The synthesis for fullerene phosphonic acid, C₆₀{>C[PO(OH)₂]₂}ₙ(OH)ₘ, with (n+m)≦60 and 2≦(n or m)≦60, were performed through Bingel type reaction, as follows in Synthesis Scheme 1 (the literature procedures were modified (Andrey L. Mirakyan and Lon J. Wilson, J. Chem. Soc., Perkin Trans. 2, 2002, 1173-1176 and Fuyong Cheng, Xinlin Yang, Hesun Zhu and Yinglin Song, Tetrahedron Lett., 41, 2000, 3947-3950)):

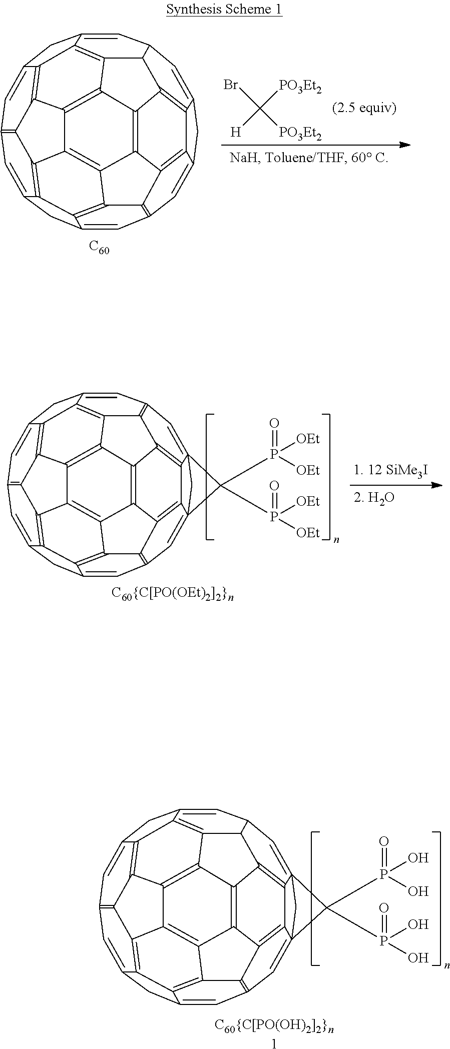

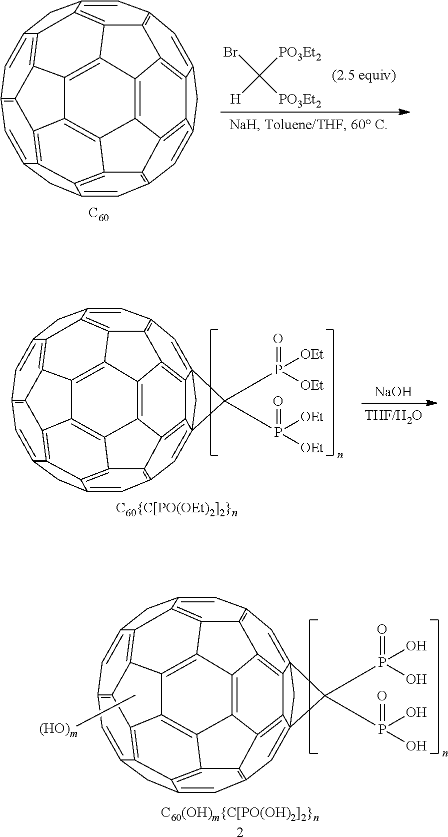

Another fullerene phosphoric acid derivative, C₆₀[PO(OH)₂]ₙ(OH)ₘ, with (n+m)≦60 and 2≦(n or m)≦60 was synthesized as follows in Synthesis Scheme 2:

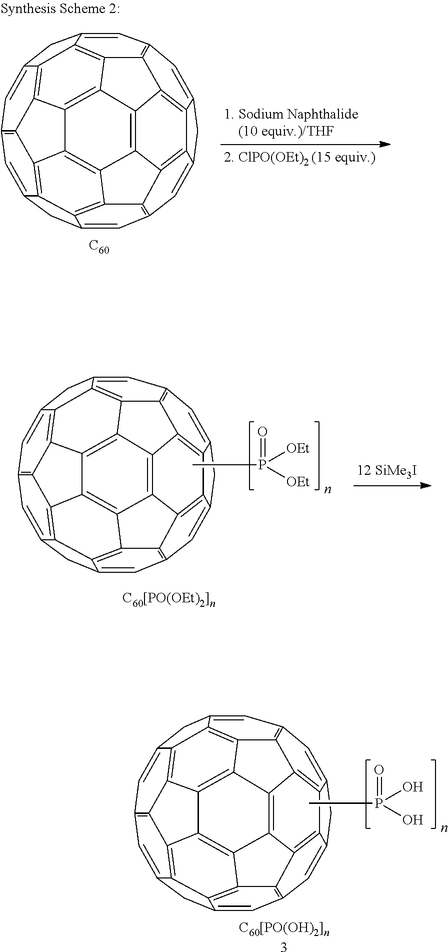

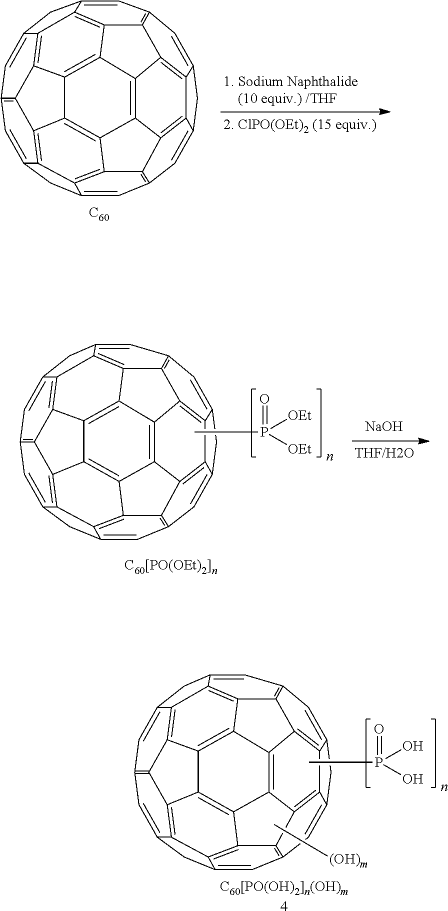

Other similarly prepared fullerene derivatives include, but are not limited to, fullerene derivatives have functional groups such as: >C[PO(OH)₂]₂; —PO(OH)₂; —OH; —SO₃H; —NH₂; —CN; —HOSO₃H; —COOH; —OPO(OH)₂; and —OSO₃, or a combination of two or more of those groups attached to the fullerene.

### Example 2

### Preparation of C₆₀-Nafion Composite Membranes

13 g of 5 wt % Nafion solution in isopropanol, obtained from Alfa Aeser, was dried in a Teflon dish at 80° C. in an oven purged with air at 200 mL/min for about 8 to 10 hours. The amount of dry Nafion obtained was weighed after drying the isolated polymer at 105° C. under vacuum for about 1 hour. The yield was 0.650 g of a dry Nafion membrane. 0.6094 g of a dry Nafion membrane thus obtained was cut into small pieces and dissolved in 10 mL dry dimethyl acetamide at about 80 to 90° C. After the Nafion dissolved completely, 2 mL of ortho-dichlorobenzene was added to the solution at about 80 to 90° C. with vigorous stirring for about half an hour. Simultaneously, 6.15 mg of C₆₀ (1 wt %) was dissolved in 2 mL of chlorobenzene at room temperature. The C₆₀ solution in chlorobenzene was added to the Nafion solution while simultaneously adding 4.0 mL of chlorobenzene at about 80 to 90° C. with vigorous stirring for about 4 hours. The purple solution turned clear brown. The mixture was then poured into a 6.4 cm diameter Teflon dish. The membrane was cast in an oven at 120° C. and purged with air at 200 mL/min overnight. The membrane was annealed at 170° C., by ramping the temperature to 150° C. for 1 hr and then to 170° C. for 1 hour. The membrane in the casting dish was soaked in water and then peeled from the casting dish.

### Example 3

### Preparation of C₆₀(OH)ₙ Nafion Composite Membranes

0.650 g of a dry Nafion membrane obtained from the Nafion isopropanol solution described above was cut into small pieces and dissolved in 10 mL of dry dimethyl acetamide at 80° C. 6.5 mg of C₆₀(OH)ₙ, with n=2 to 60, specifically n=12 for this example, was dissolved in 5 mL of dry dimethyl acetamide at room temperature. This solution in dimethyl acetamide was added to the Nafion solution in dimethyl acetamide at 80° C. while stirring. The mixture was stirred for half an hour at 80° C. and then poured into a 6.4 cm diameter Teflon dish. The membrane was cast in an oven at 120° C. and purged with air at 200 mL/min overnight. The membrane was annealed at 170° C., by ramping the temperature to 150° C. for 1 hour and then to 170° C. for 1 hour. The membrane in the casting dish was soaked in water and the peeled from the casting dish.

### Example 4

### Preparation of C₆₀{>C[PO(OH)₂]₂}ₙ(OH)ₘ Nafion Composite Membranes

0.650 g of a dry Nafion membrane obtained from the Nafion isopropanol solution described above was cut into small pieces and dissolved in 10 mL of dry dimethyl acetamide at 80° C. 6.5 mg of C₆₀{>C[PO(OH)₂]₂}ₙ(OH)ₘ with (n+m)≦60 and 2≦(n or m)≦60 was dissolved in 5 mL of dry dimethyl acetamide at room temperature. This solution in dimethyl acetamide was added to the Nafion solution in dimethyl acetamide at 80° C. while stirring. The mixture was stirred for half an hour at 80° C. and then poured into a 6.4 cm diameter Teflon dish. The membrane was cast in an oven at 120° C. and purged with air at 200 mL/min overnight. The membrane was annealed at 170° C., by ramping the temperature to 150° C. for 1 hour and then to 170° C. for 1 hour. The membrane in the casting dish was soaked in water and the peeled from the casting dish.

### Example 5

### Preparation of C₆₀[PO(OH)₂]ₙ Nafion Composite Membranes

0.650 g of a dry Nafion membrane obtained from the Nafion isopropanol solution described above was cut into small pieces and dissolved in 10 mL of dry dimethyl acetamide at 80° C. 6.5 mg of C₆₀[PO(OH)₂]ₙ, with n=2 to 60, was dissolved in 5 mL of dry dimethyl acetamide at room temperature. This solution in dimethyl acetamide was added to the Nafion solution in dimethyl acetamide at 80° C. while stirring. The mixture was stirred for half an hour at 80° C. and then poured into a 6.4 cm diameter Teflon dish. The membrane was cast in an oven at 120° C. and purged with air at 200 mL/min overnight. The membrane was annealed at 170° C., by ramping the temperature to 150° C. for 1 hour and then to 170° C. for 1 hour. The membrane in the casting dish was soaked in water and the peeled from the casting dish.

### Example 6

### Preparation of Doped Membranes

For exemplary purposes, and not by way of limitation, Nafion 117 was used as a host polymer to fabricate a composite membrane. Nafion 117, soaked in MeOH, was mixed with C₆₀ in toluene solution to make a C₆₀ doped Nafion membrane (to be denoted as C₆₀/Nafion). The same procedure was taken for doping of PHF into a Nafion 117 membrane except that THF was used as a solvent for the fullerene, not toluene. The doped membranes were dried in an oven at 80° C. overnight. The loading of each dopant in the Nafion membrane was approximately 1 wt %.

### Example 7

### Preparation of C₆₀H(CN)₃

For the preparation of C₆₀H(CN)₃ a degassed solution of NaCN (20 mg, 1.2 eq.) in DMF (20 mL) was added to a degassed solution of C₆₀(CN)₂ (260 mg, 0.34 mmol.) in ODCB (30 mL) via canula at room temperature. After being stirred 3 minutes, the resultant deep green solution was treated with percholoric acid (0.25 mL). After 30 minutes, the brown mixture was concentrated and the solid obtained was chromatographed on silica gel (CS₂/Toluene (1:3)), C₆₀H(CN)₃ was dissolved in ODCB and crystallized by adding ethyl ether or methanol (51% yield). It is noted that during the synthesis of C₆₀H(CN)₃, that the acidity of trifluoroacetic acid (pKa: 0.52) is not strong enough to protonate the C₆₀(CN)₃⁻ and a stronger acid like perchloric acid (pKa: −1.6) was needed to protonate efficiently this anion. This approach made it possible to obtain C₆₀H(CN)₃ in a 51% yield (double that obtained from TFA).

### Example 8

### Methanol Permeability Measurements

The methanol permeability of the composite membranes were measured using the cell shown in the FIG. 1. Specifically, the lower part of the cell, which is a 20-mL glass vial, is filled with 10 mL methanol. Methanol molecules from the liquid phase vaporize and diffuse along the concentration gradient through the membrane, which is clamped between the mouth of the vial (˜2 cm in diameter) and the cap. The cap has an ˜1 cm hole so that the methanol molecules that diffuse through the membrane can escape. A fan was used to maintain the methanol concentration in the environment above the surface of the membrane at a minimum. The mass of the methanol inside the cell is measured as a function of time. For the results reported here, the methanol permeability (P) was calculated by applying Fick's first law:

$$J = - D \frac{d {C}_{m}}{d x} = - DK \frac{Δ {C}_{b}}{L} = - P \frac{Δ {C}_{b}}{L} \qquad ( 1 )$$

where J is the molar flux of methanol, D is the methanol diffusivity, K is the partition coefficient or the solubility of methanol in the membrane, Cₘ the methanol concentration in the membrane and C_{b} is the methanol concentration in the gas phase, and L is the thickness of the membrane. In this device, it is difficult to quantify accurately the value of ΔC_{b} To circumvent this problem, a reference sample with known methanol permeability (i.e., Nafion) was tested and the methanol permeability of the samples were reported relative to the methanol permeability of the reference sample. In this way, the driving force term (ΔC) in Equation 1 cancels out (see Equation immediately 2 below).

$$\frac{{J}_{sample} {L}_{sample}}{{J}_{reference} {L}_{reference}} = \frac{{P}_{sample}}{{P}_{reference}} \qquad ( 2 )$$

As seen in Table 1, the MeOH permeability is expressed relative to that of Nafion, with the permeability for Nafion being 1. The permeability seems to vary from one fullerene to the other and it tends to be reduced with increasing loading of fullerene which demonstrates the effectiveness of the fullerenes in reduction of MeOH permeability. C₆₀{>C[PO(OH)₂]₂}ₙ(OH)ₘ with (n+m)≦60 and 2≦(n or m)≦60 has the best effect of reducing the MeOH permeability among the fullerenes.

Although the description above contains many details, these should not be construed as limiting the scope of the invention but as merely providing illustrations of some of the presently preferred embodiments of this invention. Therefore, it will be appreciated that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more.” All chemical and functional equivalents to the elements of the above-described preferred embodiment that are known to those of ordinary skill in the art are expressly incorporated herein by reference and are intended to be encompassed by the present claims. Moreover, it is not necessary for a system, apparatus, or compound to address each and every problem sought to be solved by the present invention, for it to be encompassed by the present claims.

TABLE 1
Methanol Permeability of the Fullerene Composite Membranes

| Loading | C₆₀— | C₆₀(OH)₁₂— | C₆₀H(CN)₃— | |
|---|---|---|---|---|
| wt % | Nafion | Nafion | Nafion | C₆₀{>C[PO(OH)₂]₂}ₙ(OH)ₘ |
| 1 | 0.87 | 0.98 | 0.94 | 0.78 |
| 2 | — | 0.90 | 0.83 | — |
| 10 | — | — | — | 0.62 |
| 18 | — | 0.75 | — | — |

What is claimed is:

1. For use in a DMFC, a proton-conducting membrane comprising:
a) a proton-conducting host polymer and
b) a functionalized fullerene.

2. A proton-conducting membrane according to claim 1, wherein said functionalized fullerene is physically mixed with said proton-conducting polymer.

3. A proton-conducting membrane according to claim 1, wherein said functionalized fullerene is covalently bonded to said proton-conducting polymer.

4. A proton-conducting membrane according to claim 1, wherein said proton-conduction polymer is selected from a group consisting of Nafion, poly(arylene ether sulfone), poly(phosphazines), polyethers, poly(vinyl pyrrolidone), and poly(phenylene ether).

5. A proton-conducting membrane according to claim 1, wherein said proton-conducting polymer is a combination of one two or more proton-conducting species.

6. A proton-conducting membrane according to claim 5, wherein said proton-conducting species are selected from a group consisting of Nafion, poly(arylene ether sulfone), poly(phosphazines), polyethers, poly(vinyl pyrrolidone), and poly(phenylene ether).

7. A proton-conducting membrane according to claim 1, wherein said proton-conducting polymer is Nafion.

8. A proton-conducting membrane according to claim 1, wherein said functionalized fullerene is selected from a group consisting of proton acceptors and proton donors.

9. A proton-conducting membrane according to claim 1, wherein said functionalized fullerene is functionalized with one or more functional groups selected from a group consisting of >C[PO(OH)₂]₂, —PO(OH)₂, —OH, —SO₃H, —NH₂, —CN; —HOSO₃H, —COOH, —OPO(OH)₂, —OSO₃, and a combination of two or more of these groups.

10. A proton-conducting membrane according to claim 1, wherein said functionalized fullerene is functionalized with a combination of one or more functional groups selected from a group consisting of >C[PO(OH)₂]₂, —PO(OH)₂, —OH, —SO₃H, —NH₂, —CN; —HOSO₃H, —COOH, —OPO(OH)₂, and —OSO₃.

11. A proton-conducting membrane according to claim 1, wherein an amount of said functionalized fullerene within the proton-conducting membrane ranges between about >0 wt % to <100 wt %.

12. A proton-conducting membrane according to claim 1, wherein said functionalized fullerene comprises a fullerene cage and a functional group, wherein said fullerene cage and said functional group are separated by ≦5 atoms.

13. For use in a DMFC, a proton-conducting membrane comprising:
a) a proton-conducting host polymer and
b) a functionalized fullerene selected from a group consisting of proton acceptors and proton donors.

14. A proton-conducting membrane according to claim 13, wherein said functionalized fullerene is physically mixed with said proton-conducting polymer.

15. A proton-conducting membrane according to claim 13, wherein said functionalized fullerene is covalently bonded to said proton-conducting polymer.

16. A proton-conducting membrane according to claim 13, wherein said proton-conduction polymer is selected from a group consisting of Nafion, poly(arylene ether sulfone), poly(phosphazines), polyethers, poly(vinyl pyrrolidone), and poly(phenylene ether).

17. A proton-conducting membrane according to claim 13, wherein said proton-conducting polymer is a combination of one two or more proton-conducting species.

18. A proton-conducting membrane according to claim 17, wherein said proton-conducting species are selected from a group consisting of Nafion, poly(arylene ether sulfone), poly(phosphazines), polyethers, poly(vinyl pyrrolidone), and poly(phenylene ether).

19. A proton-conducting membrane according to claim 13, wherein said proton-conducting polymer is Nafion.

20. A proton-conducting membrane according to claim 13, wherein said functionalized fullerene is functionalized with one or more functional groups selected from a group consisting of >C[PO(OH)₂]₂, —PO(OH)₂, —OH, —SO₃H, —NH₂, —CN; —HOSO₃H, —COOH, —OPO(OH)₂, —OSO₃, and a combination of two or more of these groups.

21. A proton-conducting membrane according to claim 13, wherein said functionalized fullerene is functionalized with a combination of one or more functional groups selected from a group consisting of >C[PO(OH)₂]₂, —PO(OH)₂, —OH, —SO₃H, —NH₂, —CN; —HOSO₃H, —COOH, —OPO(OH)₂, and —OSO₃.

22. A proton-conducting membrane according to claim 13, wherein an amount of said functionalized fullerene within the proton-conducting membrane ranges between about >0 wt % to <100 wt %.

23. A proton-conducting membrane according to claim 13, wherein said functionalized fullerene comprises a fullerene cage and a functional group, wherein said fullerene cage and said functional group are separated by ≦5 atoms.

24. For use in a DMFC, a proton-conducting membrane comprising:
a) a proton-conducting host polymer selected from a group consisting of Nafion, poly(arylene ether sulfone), poly(phosphazines), polyethers, poly(vinyl pyrrolidone), and poly(phenylene ether) and
b) a functionalized fullerene selected from a group consisting of proton acceptors and proton donors.

25. A proton-conducting membrane according to claim 24, wherein said functionalized fullerene is physically mixed with said proton-conducting polymer.

26. A proton-conducting membrane according to claim 24, wherein said functionalized fullerene is covalently bonded to said proton-conducting polymer.

27. A proton-conducting membrane according to claim 24, wherein said proton-conducting polymer is a combination of one two or more proton-conducting species.

28. A proton-conducting membrane according to claim 27, wherein said proton-conducting species are selected from a group consisting of Nafion, poly(arylene ether sulfone), poly(phosphazines), polyethers, poly(vinyl pyrrolidone), and poly(phenylene ether).

29. A proton-conducting membrane according to claim 24, wherein said proton-conducting polymer is Nafion.

30. A proton-conducting membrane according to claim 24, wherein said functionalized fullerene is functionalized with one or more functional groups selected from a group consisting of >C[PO(OH)₂]₂, —PO(OH)₂, —OH, —SO₃H, —NH₂, —CN; —HOSO₃H, —COOH, —OPO(OH)₂, —OSO₃, and a combination of two or more of these groups.

31. A proton-conducting membrane according to claim 24, wherein said functionalized fullerene is functionalized with a combination of one or more functional groups selected from a group consisting of >C[PO(OH)₂]₂, —PO(OH)₂, —OH, —SO₃H, —NH₂, —CN; —HOSO₃H, —COOH, —OPO(OH)₂, and —OSO₃.

32. A proton-conducting membrane according to claim 24, wherein an amount of said functionalized fullerene within the proton-conducting membrane ranges between about >0 wt % to <100 wt %.

33. A proton-conducting membrane according to claim 24, wherein said functionalized fullerene comprises a fullerene cage and a functional group, wherein said fullerene cage and said functional group are separated by ≦5 atoms.

34. For use in a DMFC, a proton-conducting membrane comprising:
a) a Nafion proton-conducting host polymer and
b) a functionalized fullerene wherein a functionalizing group is selected from a group consisting of >C[PO(OH)₂]₂, —PO(OH)₂, —OH, —SO₃H, —NH₂, —CN; —HOSO₃H, —COOH, —OPO(OH)₂, —OSO₃, and a combination of two or more of these groups, wherein an amount of said functionalized fullerene within the proton-conducting membrane ranges between about >0 wt % to <100 wt %, wherein said functionalized fullerene comprises a fullerene cage and a functional group, and wherein said fullerene cage and said functional group are separated by ≦5 atoms.
